(19) United States
(12) Patent Application Publication
(10) Pub. No.: US 2018/0189702 A1
(43) Pub. Date: Jul. 5, 2018

(54) POWER DISTRIBUTION SYSTEM OPTIMIZATION FOR WELL STIMULATION AND SERVICING ENVIRONMENTS

(71) Applicant: Halliburton Energy Services, Inc., Houston, TX (US)

(72) Inventors: Timothy Holiman Hunter, Duncan, OK (US); Glenn Howard Weightman, Duncan, OK (US); Carlos Alfredo Vallejo, Humble, TX (US); Alexander Simon Chretien, Duncan, OK (US); John Carl Reid, Duncan, OK (US)

(21) Appl. No.: 15/394,064

(22) Filed: Dec. 29, 2016

(51) Int. Cl. G06Q 10/06; G06F 17/50

(52) U.S. Cl. CPC G06Q 10/06313; G06F 2217/78; G06F 17/5009

(57) ABSTRACT

A job plan may be developed far in advance of actual execution of any one or more specified well servicing operations. To account for all the factors, parameters or conditions that occur at an actual well site a revised job plan may be generated that accounts for the actual site equipment available, environmental factors, one or more costs, available power source, optimal operation of equipment and any other factors. Any one or more of the factors may be weighted according to a particular physical location or other factors of the job plan. Correlating the collected, known, and actual information about equipment and a physical location allows for the generation of an optimized revised job plan that provides better utilization of equipment, including power sources, and control of costs.

### TECHNICAL FIELDS

The present disclosure relates generally to power distribution systems, and more specifically (although not necessarily exclusively), to systems and methods for optimizing a power distribution system for performing well stimulation and well servicing.

### BACKGROUND

In general, conventional power distribution configurations and management for an environment, such as a well stimulation and servicing environment are determined on an ad hoc basis. Selection of power units, well stimulation and servicing equipment, lighting, and other necessary job site equipment and arrangement of this equipment may be based on a standard or default workflow and site plan. That is, the power distribution configuration and management may not be customized for a given drilling, exploration or production operation. The lack of planning and customization of the power distribution configuration and management may increase costs, for example, resources may not be utilized at optimal operating levels or certain equipment may experience down time due to lack of an adequate power supply which may cause delays or prolong a given operation.

### BRIEF DESCRIPTION OF THE DRAWINGS

FIG. 1 is a schematic diagram of an apparatus for transferring material in a wellbore.

FIG. 2 is a diagram illustrating an example information handling system, according to one or more aspects of the present disclosure.

FIG. 3 is a schematic diagram of an optimized power distribution configuration for pumping materials, according to one or more aspects of the present disclosure.

FIG. 4 is a flowchart for generating an optimized well servicing equipment job plan for a well servicing environment, according to one or more aspects of the present disclosure.

FIG. 5 is a flowchart for optimization of well servicing equipment during a well servicing operation, according to one or more aspects of the present disclosure.

### DETAILED DESCRIPTION

Certain aspects and features of the present disclosure relate to an efficient and optimized power distribution configuration and management. One or more parameters associated with an environment, for example, a given well stimulation and servicing environment, are processed to determine an optimized power distribution configuration and management for the given environment.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

Certain aspects and features of the present disclosure may require an information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. The information handling system may also include one or more interface units capable of transmitting one or more signals to a controller, actuator, or like device.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

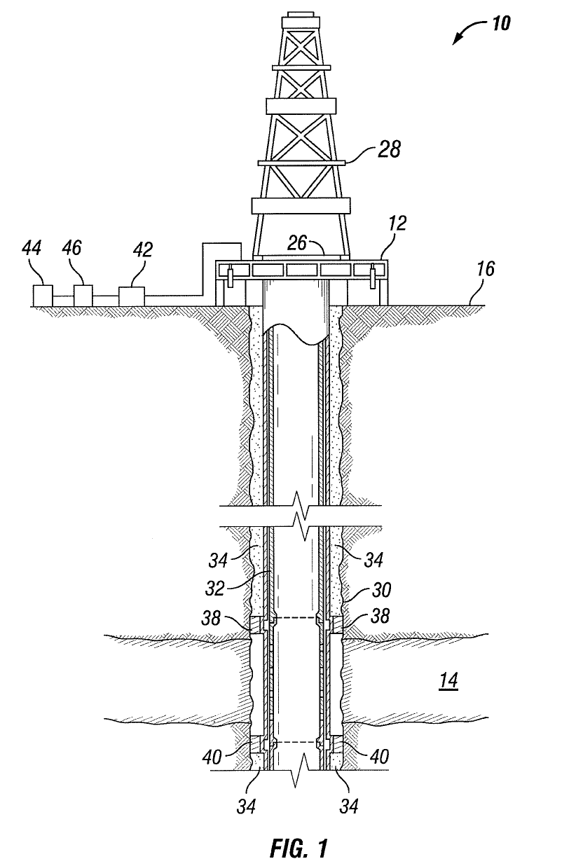

FIG. 1 is a schematic diagram of a wellbore stimulation and servicing environment 10 for transferring material in and for production of fluid from a wellbore 30. Generally, wellbore stimulation and servicing environment 10 illustrates a system for transferring material from a surface-located hydrocarbon well site 12. The well site 12 is located over a hydrocarbon bearing formation 14, which is located below a ground surface 16. At certain times during the management and operation of the wellbore stimulation and servicing environment 10, the well site 12 may comprise a hoisting apparatus 26 and a derrick 28 for raising and lowering pipe strings such as a work string, drill string or any other mechanism for deploying downhole tools, such as a bottom hole assembly, a drill bit, sensors, or any other device or combination thereof. While well site 12 is illustrated at a ground surface 16, the present disclosure contemplates any one or more embodiments implemented at a well site at any location, including, at sea above a subsea hydrocarbon bearing formation. While well site 12 is illustrated at a ground surface 16, the present disclosure contemplates any one or more embodiments implemented at a well site at any location, including, at sea above a subsea hydrocarbon bearing formation.

The well bore 30 is formed through various earth strata including the formation 14. A pipe or casing 32 is insertable into the wellbore 30 and may be cemented within the wellbore 30 by cement 34. A centralizer/packer device 38 may be located in the annulus between the well bore 30 and the casing 32 just above the formation 14, and a centralizer packer device 40 is located in the annulus between the wellbore 30 and the casing 32 just below the formation 14. Site equipment 42 according to one or more aspects of the present disclosure is located at or about the well site 12 or the wellbore stimulation and servicing environment 10. Site equipment 42 comprises one or more pieces of equipment and is coupled to power distribution unit 42 and one or more pieces of site equipment 42 may be coupled to control system 44. The site equipment 42 may comprise any type of equipment that requires power from power distribution unit 46. In one or more embodiments, site equipment 42 comprises a pumping system, an elevator, a fan, lighting device, and any other equipment required for a wellbore stimulation and servicing operation. For example, site equipment 42 may comprise a pumping system according to one or more aspects of the present disclosure that is configured to transfer material including but not limited to, water, gel (for example, linear gel, cross-linked gel, Zanthan based gel or any other gel), breaker, friction reducer, surfactant, biocide, sand, proppant, diverter, acid, gas (for example, nitrogen, natural gas, carbon dioxide or any other type of gas), any type of stimulation fluid (for example, a fracking fluid) or any combination thereof. In one or more embodiments, site equipment 42 may be disposed or positioned at or about the well site 12 or the wellbore stimulation and servicing environment 10.

Site equipment 42 receives power from power distribution unit 46. Power distribution unit 46 may comprise any type of power equipment, device, or mechanism. In one or more embodiments, power distribution unit 46 may comprise one or more turbines, generators (for example, an electric generator, a gas generator, a diesel generator, or any combination thereof). In one or more embodiments, power distribution unit 46 may be used as a power source for any one or more other types of equipment located at or about the well site 12 or the wellbore stimulation and servicing environment 10. Each type of power distribution unit 46 has associated one or more known, published, or otherwise available ratings, settings, parameters or any other operating condition that identifies the optimal operating state for the power distribution unit 46. For example, one or more parameters associated with the operation of the power distribution unit 46 may include, but are not limited to, fuel type, fuel consumption, fuel quality, environmental parameters (for example, elevation, barometric pressure, temperature, humidity or any other environmental condition) rated driving power, watts, voltage, amps, altitude, sound, size, rated power, rated speed, load capacity, or any other operating condition. In one or more embodiments, one or more of the environmental parameters or factors may be retrieved using a global positioning system (GPS) or weather service (for example, an on-line weather service or portal). In one or more embodiments any of the one or more parameters may be received, determined or otherwise collected in real-time.

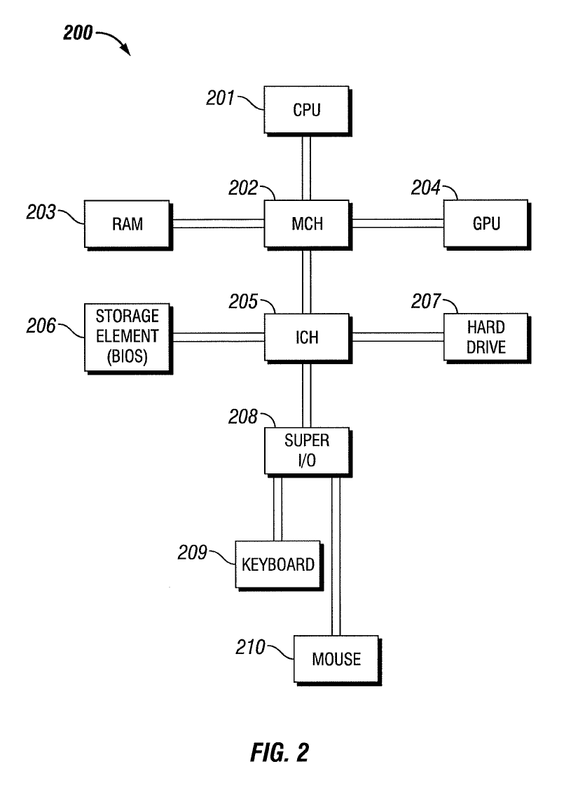

One or more control systems 44 may be deposed or positioned at or about the well site 12 or the wellbore stimulation and servicing environment 10. In one or more embodiments, control system 44 may be located remote from the well site 12. Site equipment 42, the power distribution unit 46 or any combination thereof may be controlled by a control system 44 located at the well site 12. In one or more embodiments, control system 44 may comprise one or more information handling systems, such as the information handling system 200 described with respect to FIG. 2. Control system 44 may comprise one or more instructions or software programs stored on a non-transitory storage medium that when executed perform one or more embodiments of the present disclosure.

FIG. 2 is a diagram illustrating an example information handling system 200, according to aspects of the present disclosure. The control system 44 may take a form similar to the information handling system 200 or include one or more components of information handling system 200. A processor or central processing unit (CPU) 201 of the information handling system 200 is communicatively coupled to a memory controller hub (MCH) or north bridge 202. The processor 201 may include, for example a microprocessor, microcontroller, digital signal processor (DSP), application specific integrated circuit (ASIC), or any other digital or analog circuitry configured to interpret and/or execute program instructions and/or process data. Processor 201 may be configured to interpret and/or execute program instructions or other data retrieved and stored in any memory such as memory 203 or hard drive 207. Program instructions or other data may constitute portions of a software or application for carrying out one or more methods described herein. Memory 203 may include read-only memory (ROM), random access memory (RAM), solid state memory, or disk-based memory. Each memory module may include any system, device or apparatus configured to retain program instructions and/or data for a period of time (e.g., computer-readable non-transitory media). For example, instructions from a software or application may be retrieved and stored in memory 203 for execution by processor 201.

Modifications, additions, or omissions may be made to FIG. 2 without departing from the scope of the present disclosure. For example, FIG. 2 shows a particular configuration of components of information handling system 200. However, any suitable configurations of components may be used. For example, components of information handling system 200 may be implemented either as physical or logical components. Furthermore, in some embodiments, functionality associated with components of information handling system 200 may be implemented in special purpose circuits or components. In other embodiments, functionality associated with components of information handling system 200 may be implemented in configurable general purpose circuit or components. For example, components of information handling system 200 may be implemented by configured computer program instructions.

Memory controller hub 202 may include a memory controller for directing information to or from various system memory components within the information handling system 200, such as memory 203, storage element 206, and hard drive 207. The memory controller hub 202 may be coupled to memory 203 and a graphics processing unit 204. Memory controller hub 202 may also be coupled to an I/O controller hub (ICH) or south bridge 205. I/O controller hub 205 is coupled to storage elements of the information handling system 200, including a storage element 206, which may comprise a flash ROM that includes a basic input/output system (BIOS) of the computer system. I/O controller hub 205 is also coupled to the hard drive 207 of the information handling system 200. I/O controller hub 205 may also be coupled to a Super I/O chip 208, which is itself coupled to several of the I/O ports of the computer system, including keyboard 209 and mouse 210.

In certain embodiments, the control system 44 may comprise an information handling system 200 with at least a processor and a memory device coupled to the processor that contains a set of instructions that when executed cause the processor to perform certain actions. In any embodiment, the information handling system may include a non-transitory computer readable medium that stores one or more instructions where the one or more instructions when executed cause the processor to perform certain actions. As used herein, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a computer terminal, a network storage device, or any other suitable device and may vary in size, shape, performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

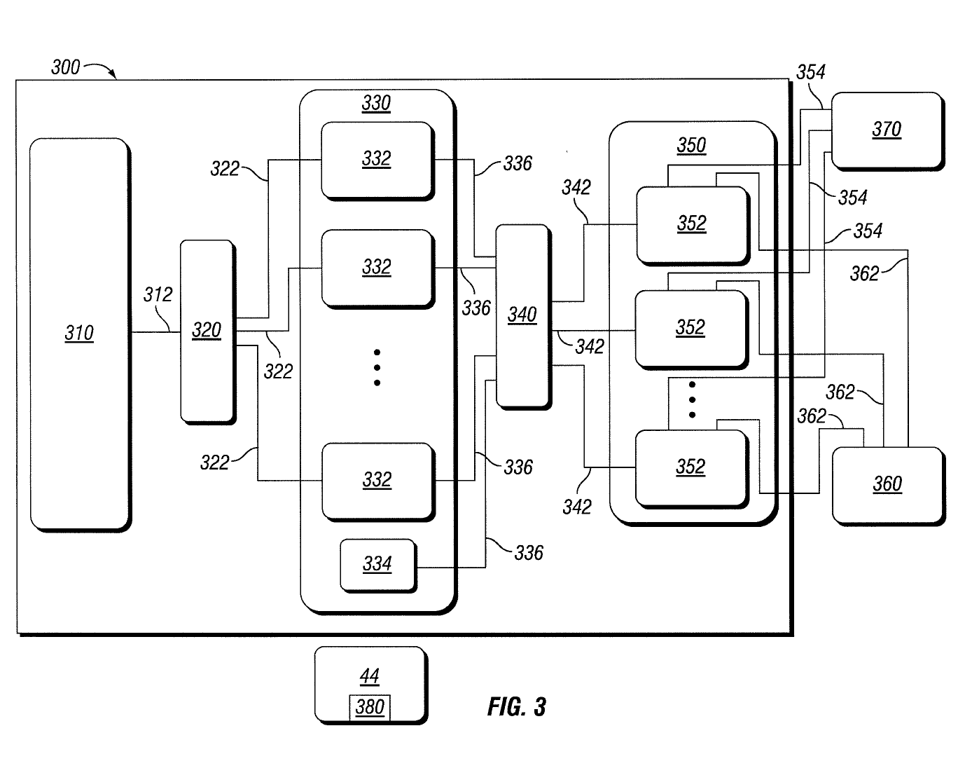

FIG. 3 is a schematic diagram of an optimized power distribution and well stimulation and servicing configuration 300 for pumping materials 360 to a location, for example, downhole such as in wellbore 30 of FIG. 1, according to aspects of the present disclosure. In one or more embodiments, of an optimized power distribution and well stimulation and servicing configuration 300 comprises an engine 310 (for example, power distribution unit 46 in FIG. 1), a gearbox 320, a hydraulic pumping system 330 (or any other type of pumping system), an intensifier control system 340, an intensifier system 350, and a control system 44. Any one or more components of the optimized power distribution and well stimulation and servicing configuration 300 may be located on the surface 16, a truck, a trailer, a barrel, a tank, a skid, a vessel, a railcar, any other vehicle or any other suitable location. In one or more embodiments, engine or motor 310 may comprise one or more turbines, generators, engines or motors. The engine 310 may comprise an electric, diesel, gas, wind, water or any other suitable engine, motor or turbine for providing power to one or more hydraulic pumps 332 (for example, a positive displacement pump or a variable displacement pump). The type of engine 310 may depend on one or more factors including, but not limited to, any one or more of the efficiency of the engine 310, the required speed, torque level, power capacity, and pressure required by the hydraulic pumping system 330, weight, size or power density of engine 310, cost of engine 310, fuel type, fuel efficiency, temperature, sound emissions, exhaust emissions, or any other parameters.

Power from the engine 310 may be transferred to or used to drive one or more hydraulic pumps 332 via a gearbox 320. A drive shaft or drive line 312 from engine 310 may couple to gearbox 320. Gearbox 320 may couple to one or more hydraulic pumps 332 of the hydraulic pump system 330. Gearbox 320 may couple to the high-speed shaft of the engine 310 and the low-speed shaft of the associated one or more hydraulic pumps 332. In one or more embodiments, one or more engines 310 may couple to corresponding one or more gearboxes 320 via one or more drive lines 312. Each gearbox 320 may couple to any one or more hydraulic pumps 332. In one or more embodiments, the gearbox 320 is not necessary and one or more engines 310 couple to one or more hydraulic pumps 332.

Hydraulic pumping system 330 may comprise one or more hydraulic pumps 332 for pumping hydraulic fluid 334 to one or more intensifiers 352. In one or more embodiments, a site equipment 42 may comprise any number or quantity and any type of hydraulic pumping systems 330. For example, in one or more embodiments, any number of hydraulic pumps 332 may pump hydraulic fluid 334. In one or more embodiments, hydraulic fluid 334 may be pumped by the hydraulic pumps 332 from any hydraulic fluid source. The hydraulic fluid source may comprise a reservoir, a container on the surface 16, a truck, a trailer, a barrel, a tank, or any other location or vehicle, a vessel, a railcar, or any other suitable device for storing hydraulic fluid or any combination thereof.

Any one or more of the hydraulic pumps 332 may be coupled to an intensifier control system 340 via one or more associated hydraulic fluid flow lines 336. Intensifier control system 340 may comprise or be coupled to an information handling system 200 (not shown) for controlling the rate, volume and pressure of output of the received hydraulic fluid 334 from the fluid flow lines 336 to one or more intensifiers 352 via intensifier fluid flow lines 342. The intensifier system 350 may comprise any one or more intensifiers 352. In one or more embodiments, one or more intensifiers 352 of intensifier system 350 are selected for a given operation such that all or any one or more intensifiers 352 may be selected. In one or more embodiments, the intensifier system 350 comprises one or more banks of intensifiers where each bank of intensifiers comprises one or more intensifiers 352. Any one or more intensifiers 352 of a bank of intensifiers may be selected and individually controllable.

In one or more embodiments, output fluid or material 360 to be pumped downhole is received at or drawn into a first inlet port 356 of intensifier 352. Material 360 may comprise cement, slurry, water, air, linear gel, cross-linked gel, break, friction reducer surfactant, biocide, sand, proppant, diverter or any other fracking fluid. The intensifier 352 transforms the hydraulic power received via hydraulic fluid flow lines 342 to a force that pumps or flows the material 360 via an outlet port 358 to one or more output flow lines 354. The one or more output flow lines 354 may couple to one or more of a piping or tubing 370. Piping or tubing 370 may convey, transmit, flow or otherwise deliver the material 360 at a high pressure downhole. In one or more embodiments, the one or more output flow lines 354 may convey, transmit flow, or otherwise deliver the material 360 at a high pressure to a location, for example, downhole in wellbore 30 of FIG. 1.

In one or more embodiments, the optimized power distribution and well stimulation and servicing configuration 300 for pumping materials 360 downhole is configured based, at least in part, on one or more operating parameters associated with the engine 310 or power distribution unit 46 in FIG. 1. For example control system 44, or any other information handling system 200, may comprise a database 380. Database 380 stores information associated with any one or more operating parameters associated with the engine 310 or power distribution unit 46 in FIG. 1, hydraulic pumping system 330 or site equipment 42 in FIG. 1, any other equipment at or about the well site 12 or the wellbore stimulation and servicing environment 10 or any combination thereof. Control system 44 may execute one or more instructions or a software program to determine an optimum configuration and management of the optimized power distribution and well stimulation and servicing configuration 300 or the wellbore stimulation and servicing environment 10. While FIG. 3 is described with respect to a well stimulation and servicing configuration or wellbore stimulation and servicing environment 10, any one or more aspects of FIG. 3 may be applicable to any operation at any location or environment that requires pumping of a fluid or material.

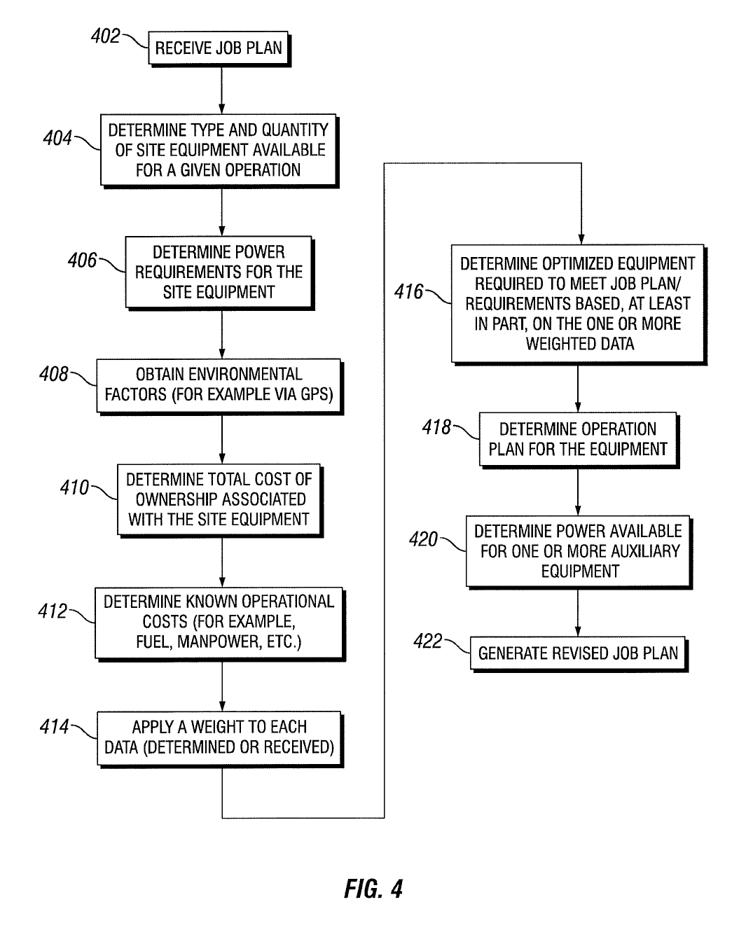

FIG. 4 is a flowchart for generating an optimized well servicing equipment job plan for a well servicing environment, according to one or more aspects of the present disclosure. At step 402, a job plan is received. For example, a job plan for wellbore stimulation and servicing environment 10 of FIG. 1, a well stimulation and servicing configuration 300 of FIG. 3 or any other operation or configuration that requires pumping a material or fluid at a specified rate. Generally, before a well servicing operation begins or well servicing equipment is transported to a well site a job plan or workflow (for example, a well servicing plan) for the well site is created or generated. The job plan may be based on information collected from the operation of one or more other well sites. The job plan may comprise one or more requirements for a well servicing operation including, but not limited to, physical location of well site, type of one or more well servicing operations to be performed at the well site (for example, drilling, plug and abandonment, well stimulation, production or any other well servicing operation), type of formation, type of environment, type of one or more hydrocarbons to be produced, timeframe for each well servicing operation, footprint at the physical location for equipment setup at well site, proximity of fuel sources to well site, preferred or recommended type and quantity of equipment, preferred or recommended personnel, type and amount of well servicing fluid, chemicals, or any other required fluids (including gases) for storage and use at the well site, emission regulations (for example, noise emissions, exhaust emissions, light emissions, or any other emissions), configuration or placement of equipment at the well site or any other information necessary for the planning of a well servicing operation. In one or more embodiments, any one or more of the job plan requirements may be associated with data stored or retrievable from a repository (for example, a repository as discussed with respect to step 404), user inputs, or any other resource. For example, emission requirements for the designated physical location may be retrieved from such a repository.

At step 404, the type and quantity of site equipment available for each specified well servicing operation from the job plan is determined. The job plan may specify one or more site equipment parameters including, but not limited to, footprint, type and quantity of equipment, for example, power sources (for example, diesel or electric), pumps (for example hydraulic pumps), blending systems, manifolds, one or more downhole tools, control systems, or any other well servicing operation equipment required for any one or more well servicing operations of the job plan. In one or more embodiments, the site equipment in the job plan may be cross-referenced to an available inventory list. In one or more embodiments, a repository may store or otherwise make available for retrieval information associated with an inventory or any one or more site equipment parameters. A repository may comprise any one or more of a database and an interface. For example, an interface may comprise one or more of a web interface, an application programming interface (API), an interface to a software program, or any other interface from which data may be requested and retrieved. In one or more embodiments, the available equipment may be retrieved from an inventory database that provides information as to the footprint, quantity and type of equipment in stock and the availability of the equipment. For example, the equipment may be in use by a separate well servicing operation or may not be physically transportable to the physical location specified in the job plan. For any given well servicing operation, the specified footprint, type and quantity of equipment in the job plan may differ from the actual available equipment at or to be transported to the well site. In one or more embodiments, equipment may be determined to be available for a given timeframe of one or more well servicing operations. The determination of the footprint, type and quantity of site equipment available may include such equipment and may indicate the limited availability based on the timeframe.

At step 406, the power requirements for each site equipment necessary or required by the job plan for each specified well servicing operation is determined. The power requirements may be determined based, at least in part on, an analysis of the ramp-up and ramp-down power requirements, job site conditions (for example, any one or more environmental factors), operating capacity or condition, and timeframe of usage for each well servicing operation specified in the job plan, the determined available equipment, or both. The power requirements for site equipment may be determined based, at least in part, on one or more specifications associated with the site equipment. For example, one or more specifications associated with site equipment may be stored and retrieved from a repository as discussed above with respect to step 404.

At step 408, one or more environmental factors or parameters are obtained based, at least in part, on the physical location specified in the job plan. The environmental data may include, but are not limited to, temperature, altitude, barometric pressure, humidity, wind, or any other environmental data. In one or more embodiments, environmental data may be determined based, at least in part, on one or more of a global positioning system (GPS), a repository (as discussed above with respect to step 404, for example, a weather services web interface), one or more user inputs, or any other resource or input. In one or more embodiments, the environmental data may be obtained or collected in real-time.

At step 410, the total cost of ownership (TCO) associated with each required or available piece of site equipment. TCO may be based, at least in part, on any one or more of initial cost of acquisition, projected required horsepower, timeframe of usage, maintenance, or any other cost associated with acquisition, use, or disposal of the site equipment. The TCO for any piece of site equipment may be retrieved from a repository as discussed above with respect to step 404.

At step 412, the operational costs associated with each available or required site equipment is determined. For example, fuel (for example, natural gas, diesel, gasoline), lubricant, or any other power source (for example, electric) consumption may be determined along with the cost for such consumption for each site equipment. The operational costs may he retrieved from a repository (for example, as discussed with respect to step 404).

At step 414, a weight is applied or determined for any one or more type of data determined or received. In one or more embodiments, the weighting may be based, at least in part, on scarcity of a resource or limited availability, timeframe of usage, quantity required, harshness of the environment, remoteness of the well site, or any other factor. For example, for a remote physical location, operational costs may be weighted more heavily than power requirements.

At step 416, the optimized site equipment required for the job plan is determined based, at least in part, on the one or more weighted data. In one or more embodiments, optimizing the site equipment may require determining the total power available at the physical location for each well servicing operation. The total power available at the physical location for each well servicing operation specified in the job plan may be determined based, at least in part on, one or more environmental parameters (for example, determined at step 408), one or more power requirements (for example, determined at step 408) and any one or more associated weights. The power availability may be converted or normalized to any unit. For example, a determination of power availability in kilowatts may be converted to horsepower. The total power required to power each well servicing operation may then be determined. The total power may be based, at least in part, on any one or more of the job plan (for example, from step 402) and the available equipment (for example, determined from step 404).

In one or more embodiments, a job plan may require the pumping of well servicing fluid downhole for a given timeframe. The total power for the designated number of pumping systems in the job plan may be determined. The number of pumping systems to optimize power consumption may be determined so as to lower the total power required and optimize the equipment for the well servicing operation. For example, the job plan may require a specified number of pumping systems but the pressure/rate of pumping may be accomplished using a fewer number of pumping systems given the physical location, one or more environmental factors, or any other data and thus less power may be consumed using fewer pumping systems.

In one or more embodiments, the type of site equipment may be correlated with the operational costs (for example, from step 412). For example, an analysis may be performed that determines whether the type and quantity of equipment associated with a well servicing operation specified in the job plan is cost-efficient. For example, the job plan may specify a natural gas engine but an analysis of one or more data (for example, one or more environmental factors, fuel costs, operational costs, etc.) indicates that a diesel engine would be more cost-efficient while still providing the necessary total power requirements. Such an analysis may be performed for each type of equipment associated with each well servicing operation specified in the job plan.

In another example, an analysis may be performed to determine if the site equipment for a well servicing operation specified in the job plan exceeds operating requirements of one or more data. For example, type and usage required of site equipment for performing a specified well servicing operation at the given physical location may exceed the level of noise emissions, exhaust emissions or both specified in the job plan or retrieved from a repository. To meet such required levels, substitution of site equipment may be required (such as replacing diesel engines with natural gas engines). In one or more embodiments, such emission levels may be given a heavier weight than total power requirements such that total power requirements may be adjusted to accommodate operation within specified emission levels. In one or more embodiments, total emissions (including noise emission, exhaust emission or both) may be determined for a site equipment set using all natural gas, all diesel or any combination thereof to determine the optimal type of site equipment from the list of available equipment to meet emission level requirements. The determined total emissions may be correlated with the determined total power requirement to obtain optimized site equipment required for a specific well servicing operation.

In another example, the TCO and the operational costs (and any associated weights) for each available site equipment associated with a well servicing operation specified in the job plan may be correlated (for example, compared to one or more models) with the TCO and operational costs associated with other configurations of site equipment (for example, retrieved from a repository) to determine the optimized site equipment. For example, the job plan may specify certain types of site equipment for a well servicing operation that higher costs (for example, given one or more environmental factors) than alternative site equipment.

At step 418, an operation plan is determined for the available site equipment for each well servicing operation specified in the job plan. For example, the total power requirements may be used to determine the order that site equipment should be powered-up and powered-down so as to optimize fuel costs and power consumption based, at least in part, on any one or more data and associated weights.

At step 420, the amount of power available for one or more auxiliary site equipment at any given timeframe during any of the one or more well servicing operations in the job plan is determined. For example, during certain well servicing operations (for example, pumping stimulation fluid at a high rate downhole) all power source may be utilized at optimal operating capacity but other well servicing operations (for example, testing procedures) one or more power sources may be operating below capacity and available for use to power one or more auxiliary site equipment.

At step 422, a new job plan is generated based, at least in part, on the determinations from any one or more of step 416, step 418 and step 420. The new job plan may be displayed, printed, stored, or otherwise conveyed to a user or operator. A user or operator may be allowed to alter any one or more parameters of the new job plan. The new job plan may alter any one or more of the parameters of the job plan received at step 402 or any one or more data received or collected at any other step. In one or more embodiments, the new job plan may indicate one or more timeframes where excess power capacity exists and may recommend shutting down one or more power sources or units, connecting auxiliary equipment, performing one or more well servicing operations in a different order, or any other use of the excess power capacity. In one or more embodiments, the new job plan may indicate an alternate pumping schedule such that more pumping systems are utilized to pump slower to reduce maintenance costs or a group of pumping systems may he designated for pumping only certain non-abrasive fluids to reduce maintenance costs. In one or more embodiments, one or more power sources may be recommended to be power-down for a specific timeframe as the determined power consumption to maintain operation during less than optimal load conditions exceeds the power consumption required to power-down/power-up cycle.

In one or more embodiments, the new job plan may provide a report of a plurality of configurations. For example, a setting may indicate that a predetermined number of configurations should be reported. The report may provide timeframes for power cycles, total power consumption, TCO, operational costs, or any other data received or collected for each configuration. The report may be displayed, printed, stored, or otherwise conveyed to a user or operator.

In one or more embodiments, suggested equipment best practices may be included with the generated new job plan including, but not limited to, best practices associated with optimal power utilization, timeframe for utilization of site equipment, or any other best practices.

In one or more embodiments, any one or more of the steps 402-422 may be performed in any order or not performed at all. In one or more embodiments, at any one or more of the steps of 402-422 output may be generated or displayed to and input may be received from a user or operator.

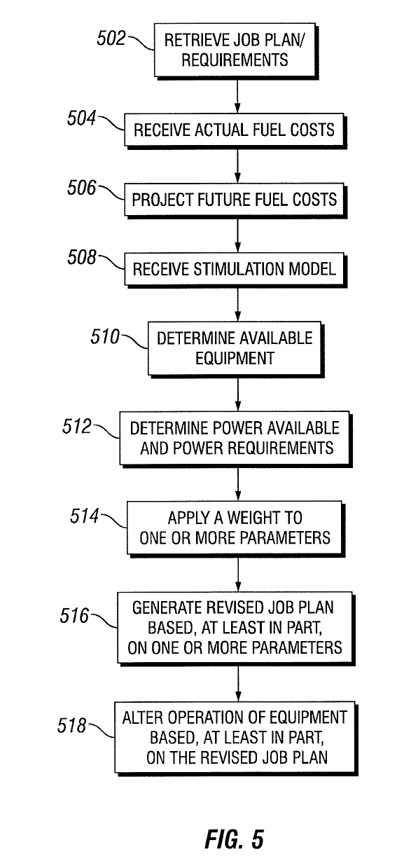

FIG. 5 is a flowchart for optimization of well servicing equipment during an operation, for example, a well servicing operation. At step 502, the requirements of the job plan are retrieved or accessed to determine the one or more site equipment and well servicing operations. At step 504, the actual fuel costs are determined or received. For example, the actual fuel costs may be continuously updated as fuel is acquired, transported, consumed, or any combination thereof by any of the one or more well servicing operation specified in the job plan. The actual fuel costs may be retrieved from a repository (for example, as discussed with respect to step 404 of FIG. 4) or received or collected via one or more inputs by a user or operator. At step 506, projected fuel costs are determined based, at least in part, on the actual fuel costs, the remaining one or more well servicing operations to be performed and the associated site equipment, one or more environmental factors, or any other data.

At step 508, the stimulation model is received for a well servicing operation. The stimulation model may be part of the received job plan at step 502, input by a user or operator, retrieved from a repository or otherwise collected or received. The stimulation model may define one or more parameters associated with a stimulation operation including, but not limited to, one or more of type of pumping system, quantity of pumping systems, required pump rate, timeframe, or any other associated parameter.

At step 510, the available site equipment for the stimulation model is determined. For example, the available site equipment may not meet one or more of the requirements of the stimulation model that may specify a quantity and type of pumping systems to pump stimulation fluid downhole at a specified pumping rate. At step 512, the power available and power requirements for the stimulation as required by the stimulation model are determined. At step 514, one or more weights may be assigned to any one or more of the parameters including, but not limited to, one or more of actual fuel costs, projected fuel costs, quantity and type of available site equipment or any other parameter.

At step 516, a new job plan is generated based, at least in part, on any of the one or more parameters or any associated weight. In one or more embodiments, a job plan requires a well servicing operation that requires a stimulation model. Any one or more of the quantity or type (or both) of site equipment specified by the stimulation model may not be available at the well site or may not be available for the given timeframe. The generated new job plan may specify alternate configurations or usage of available site equipment that meet the requirements of the stimulation model. In one or more embodiments, the quantity of a specified quantity of equipment from the stimulation model may not be available and the generated new job plan may recommend a rate of change in operation of the available site equipment to meet or approximate the requirements of the stimulation model. In one or more embodiments, the speed, rate of change, power cycle or any other operational parameter of one or more pumping systems may be altered by the generated new job plan. For example, the generated new job plan may recommend or specify using one or more soft start pumping systems in combination with one or more variable frequency drive pumping systems to meet or approximate the requirements of stimulation model. For example, one or more pumping systems may be operated at a synchronous speed and one or more other pumping systems may be operated utilizing one or more variable frequency drives with the variable frequency drives altering pumping rates to maintain the pumping rate specified in the stimulation model.

At step 518, operation of one or more site equipment is altered based, at least in part, on the generated new job plan. For example, one or more site equipment may be powered-down or powered-up, additional or auxiliary equipment may be brought online, one or more site equipment may be maintained at current operating conditions, one or more operating conditions of one or more site equipment may be altered, or any other alterations may be made to any site equipment.

In one or more embodiments, a method for generating an optimized plan for one or more well servicing operations comprises receiving a job plan for the one or more well servicing operations, determining a type and quantify of job plan equipment required by the job plan, determining a type and quantity of available equipment, determining one or more power requirements for the one or more well servicing.

In one or more embodiments, a method for generating an optimized plan for one or more well servicing operations, comprises receiving a job plan for the one or more well servicing operations, determining a type and a quantity of job plan equipment required by the job plan, determining a type and a quantity of available equipment, determining one or more power requirements for the one or more well servicing operations, obtaining one or more environmental factors, determining a cost of one or more well servicing operations, weighting each of the one or more power requirements, the one or more environmental factors and the cost, selecting one or more plan equipment from the type and the quantity of the available equipment based, at least in part, on the type and the quantity of job plan equipment for each of the one or more well servicing operations and generating one or more optimized plans for the one or more well servicing operations based, at least in part, on the one or more power requirements, the one or more environmental factors and the cost, one or more associated weights, and the one or more plan equipment. In one or more embodiments, the method for generating an optimized plan for one or more well servicing operations further comprises determining an operation plan for the quantity and the type of plan equipment for each of the one or more well servicing operations and wherein, the generated one or more optimized plans is based, at least in part, on the operation plan. In one or more embodiments, wherein at least one of the plan equipment of at least one of the generated one or more optimized plans and at least one of the job plan equipment utilize a different a fuel type. In one or more embodiments, method for generating an optimized plan for one or more well servicing operations further comprises determining a total power available for each of the one or more well servicing operations and wherein the generated one or more optimized plans is based, at least in part, on the total power available. In one or more embodiments, the method for generating an optimized plan for one or more well servicing operations further comprises determining an auxiliary power available from the total power available, wherein the auxiliary power comprises power not required for a timeframe during any of the one or more well servicing operations, determining one or more auxiliary equipment based on the auxiliary power available and wherein the generated one or more optimized plans is based, at least in part, on the total power available. In one or more embodiments, the method for generating an optimized plan for one or more well servicing operations of further comprises determining an actual fuel cost for at least one of the one or more well servicing operations, determining a projected fuel cost for the at least one of the one or more well servicing operations based, at least in part, on the determined actual fuel cost and altering an operating condition of at least one of the one or more plan equipment. In one or more embodiments, the method for generating an optimized plan for one or more well servicing operations further comprises receiving a stimulation model, wherein the stimulation model comprises a pumping rate and generating a stimulation model plan based, at least in part, on the one or more plan equipment and the pumping rate.

In one or more embodiments, an information handling system for generating an optimized plan for one or more well servicing operations comprises a processor and a non-transitory memory coupled to the processor, the non-transitory memory containing one or more instructions that, when executed by the processor, cause the processor to receive a job plan for the one or more well servicing operations, determine a type and quantity of job plan equipment required by the job plan, determine a type and a quantity of available equipment, determine one or more power requirements for the one or more well servicing operations, obtain one or more environmental factors, determine a cost of one or more well servicing operations, weight each of the one or more power requirements, the one or more environmental factors and the cost, select one or more plan equipment from the type and the quantity of the available equipment based, at least in part, on the type and the quantity of job plan equipment for each of the one or more well servicing operations and generate one or more optimized plans for the one or more well servicing operations based, at least in part, on the one or more power requirements, the one or more environmental factors and the cost, one or more associated weights, and the one or more plan equipment. In one or more embodiments, the one or more instructions that, when executed by the processor, further cause the processor to determine an operation plan for the quantity and the type of plan equipment for each of the one or more well servicing operations and wherein, the generated one or more optimized plans is based, at least in part, on the operation plan. In one or more embodiments, at least one of the plan equipment of at least one of the generated one or more optimized plans and at least one of the job plan equipment utilize a different fuel type. In one or more embodiments, the one or more instructions that, when executed by the processor, further cause the processor to determine a total power available for each of the one or more well servicing operations and wherein the generated one or more optimized plans is based, at least in part, on the total power available. In one or more embodiments, the one or more instructions that, when executed by the processor, further cause the processor to determine an auxiliary power available from the total power available, wherein the auxiliary power comprises power not required for a timeframe during any of the one or more well servicing operations, determine one or more auxiliary equipment based on the auxiliary power available and wherein the generated one or more optimized plans is based, at least in part, on the total power available. In one or more embodiments, the one or more instructions that, when executed by the processor, further cause the processor to determine an actual fuel cost for at least one of the one or more well servicing operations, determine a projected fuel cost for the at least one of the one or more well servicing operations based, at least in part, on the determined actual fuel cost and alter an operating condition of at least one of the one or more plan equipment. In one or more embodiments, the one or more instructions that, when executed by the processor, further cause the processor to receive a stimulation model, wherein the stimulation model comprises a pumping rate and generate a stimulation model plan based, at least in part, on the one or more plan equipment and the pumping rate.

In one or more embodiments, a non-transitory computer readable medium storing one or more instructions that, when executed, cause a processor to receive a job plan for the one or more well servicing operations, determine a type and quantity of job plan equipment required by the job plan, determine a type and a quantity of available equipment, determine one or more power requirements for the one or more well servicing operations, obtain one or more environmental factors, determine a cost of one or more well servicing operations, weight each of the one or more power requirements, the one or more environmental factors and the cost, select one or more plan equipment from the type and the quantity of the available equipment based, at least in part, on the type and the quantity of job plan equipment for each of the one or more well servicing operations and generate one or more optimized plans for the one or more well servicing operations based, at least in part, on the one or more power requirements, the one or more environmental factors and the cost, one or more associated weights, and the one or more plan equipment. In one or more embodiments, the non-transitory computer readable medium, wherein the one or more instructions that, when executed, further cause the processor to determine an operation plan for the quantity and the type of plan equipment for each of the one or more well servicing operations and wherein the generated one or more optimized plans is based, at least in part, on the operation plan. In one or more embodiments, wherein at least one of the plan equipment of at least one of the generated one or more optimized plans and at least one of the job plan equipment utilize a different fuel type. In one or more embodiments, the non-transitory computer readable medium, wherein the one or more instructions that, when executed, further cause the processor to determine a total power available for each of the one or more well servicing operations and wherein the generated one or more optimized plans is based, at least in part, on the total power available. In one or more embodiments, the non-transitory computer readable medium, wherein the one or more instructions that, when executed, further cause the processor to determine an auxiliary power available from the total power available, wherein the auxiliary power comprises power not required for a timeframe during any of the one or more well servicing operations, determine one or more auxiliary equipment based on the auxiliary power available and wherein the generated one or more optimized plans is based, at least in part, on the operation plan. In one or more embodiments, the non-transitory computer readable medium, wherein the one or more instructions that, when executed, further cause the processor to receive a stimulation model, wherein the stimulation model comprises a pumping rate and generate a stimulation model plan based, at least in part, on the one or more plan equipment and the pumping rate.

The foregoing description of certain aspects, including illustrated aspects, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A method for generating an optimized plan for one or more well servicing operations, comprising:
receiving a job plan for the one or more well servicing operations;
determining a type and a quantity of job plan equipment required by the job plan;
determining a type and a quantity of available equipment;
determining one or more power requirements for the one or more well servicing operations;
obtaining one or more environmental factors;
determining a cost of one or more well servicing operations;
weighting each of the one or more power requirements, the one or more environmental factors and the cost;
selecting one or more plan equipment from the type and the quantity of the available equipment based, at least in part, on the type and the quantity of job plan equipment for each of the one or more well servicing operations; and
generating one or more optimized plans for the one or more well servicing operations based, at least in part, on the one or more power requirements, the one or more environmental factors and the cost, one or more associated weights, and the one or more plan equipment.

2. The method for generating an optimized plan for one or more well servicing operations of claim 1, further comprising:
determining an operation plan for the quantity and the type of plan equipment for each of the one or more well servicing operations; and
wherein the generated one or more optimized plans is based, at least in part, on the operation plan.

3. The method for generating an optimized plan for one or more well servicing operations of claim 1, wherein at least one of the plan equipment of at least one of the generated one or more optimized plans and at least one of the job plan equipment utilize a different fuel type.

4. The method for generating an optimized plan for one or more well servicing operations of claim 1, further comprising:
determining a total power available for each of the one or more well servicing operations; and
wherein the generated one or more optimized plans is based, at least in part, on the total power available.

5. The method for generating an optimized plan for one or more well servicing operations of claim 3, further comprising:
determining an auxiliary power available from the total power available, wherein the auxiliary power comprises power not required for a timeframe during any of the one or more well servicing operations;
determining one or more auxiliary equipment based on the auxiliary power available; and
wherein the generated one or more optimized plans is based, at least in part, on the total power available.

6. The method for generating an optimized plan for one or more well servicing operations of claim 1, further comprising:
determining an actual fuel cost for at least one of the one or more well servicing operations;
determining a projected fuel cost for the at least one of the one or more well servicing operations based, at least in part, on the determined actual fuel cost; and
altering an operating condition of at least one of the one or more plan equipment.

7. The method for generating an optimized plan for one or more well servicing operations of claim 1, further comprising:
receiving a stimulation model, wherein the stimulation model comprises a pumping rate; and
generating a stimulation model plan based, at least in part, on the one or more plan equipment and the pumping rate.

8. An information handling system for generating an optimized plan for one or more well servicing operations, comprising:
a processor; and
a non-transitory memory coupled to the processor, the non-transitory memory containing one or more instructions that, when executed by the processor, cause the processor to:
receive a job plan for the one or more well servicing operations;
determine a type and quantity of job plan equipment required by the job plan;
determine a type and a quantity of available equipment;
determine one or more power requirements for the one or more well servicing operations;
obtain one or more environmental factors;
determine a cost of one or more well servicing operations;
weight each of the one or more power requirements, the one or more environmental factors and the cost;
select one or more plan equipment from the type and the quantity of the available equipment based, at least in part, on the type and the quantity of job plan equipment for each of the one or more well servicing operations; and
generate one or more optimized plans for the one or more well servicing operations based, at least in part, on the one or more power requirements, the one or more environmental factors and the cost, one or more associated weights, and the one or more plan equipment.

9. The information handling system of claim 8, wherein the one or more instructions that, when executed by the processor, further cause the processor to:
determine an operation plan for the quantity and the type of plan equipment for each of the one or more well servicing operations; and
wherein the generated one or more optimized plans is based, at least in part, on the operation plan.

10. The information handling system of claim 8, wherein at least one of the plan equipment of at least one of the generated one or more optimized plans and at least one of the job plan equipment utilize a different fuel type.

11. The information handling system of claim 8, wherein the one or more instructions that, when executed by the processor, further cause the processor to:
determine a total power available for each of the one or more well servicing operations; and
wherein the generated one or more optimized plans is based, at least in part, on the total power available.

12. The information handling system of claim 8, wherein the one or more instructions that, when executed by the processor, further cause the processor to:
determine an auxiliary power available from the total power available, wherein the auxiliary power comprises power not required for a timeframe during any of the one or more well servicing operations;
determine one or more auxiliary equipment based on the auxiliary power available; and
wherein the generated one or more optimized plans is based, at least in part, on the total power available.

13. The information handling system of claim 8, wherein the one or more instructions that, when executed by the processor, further cause the processor to:
determine an actual fuel cost for at least one of the one or more well servicing operations;
determine a projected fuel cost for the at least one of the one or more well servicing operations based, at least in part, on the determined actual fuel cost; and
alter an operating condition of at least one of the one or more plan equipment.

14. The information handling system of claim 8, wherein the one or more instructions that, when executed by the processor, further cause the processor to:
receive a stimulation model, wherein the stimulation model comprises a pumping rate; and
generate a stimulation model plan based, at least in part, on the one or more plan equipment and the pumping rate.

15. A non-transitory computer readable medium storing one or more instructions that, when executed, cause a processor to:
receive a job plan for the one or more well servicing operations;
determine a type and quantity of job plan equipment required by the job plan;
determine a type and a quantity of available equipment;
determine one or more power requirements for the one or more well servicing operations;
obtain one or more environmental factors;
determine a cost of one or more well servicing operations;
weight each of the one or more power requirements, the one or more environmental factors and the cost;
select one or more plan equipment from the type and the quantity of the available equipment based, at least in part, on the type and the quantity of job plan equipment for each of the one or more well servicing operations; and
generate one or more optimized plans for the one or more well servicing operations based, at least in part, on the one or more power requirements, the one or more environmental factors and the cost, one or more associated weights, and the one or more plan equipment.

16. The non-transitory computer readable medium of claim 15, wherein the one or more instructions that, when executed, further cause the processor to:
determine an operation plan for the quantity and the type of plan equipment for each of the one or more well servicing operations; and
wherein the generated one or more optimized plans is based, at least in part, on the operation plan.

17. The non-transitory storage medium of claim 15, wherein at least one of the plan equipment of at least one of the generated one or more optimized plans and at least one of the job plan equipment utilize a different fuel type.

18. The non-transitory computer readable medium of claim 15, wherein the one or more instructions that, when executed, further cause the processor to:
determine a total power available for each of the one or more well servicing operations; and
wherein the generated one or more optimized plans is based, at least in part, on the total power available.

19. The non-transitory storage medium of claim 15, wherein the one or more instructions that, when executed by the processor, further cause the processor to:
determine an auxiliary power available from the total power available, wherein the auxiliary power comprises power not required for a timeframe during any of the one or more well servicing operations;
determine one or more auxiliary equipment based on the auxiliary power available; and
wherein the generated one or more optimized plans is based, at least in part, on the total power available.

20. The non-transitory storage medium of claim 15, wherein the one or more instructions that, when executed by the processor, further cause the processor to:
receive a stimulation model, wherein the stimulation model comprises a pumping rate; and
generate a stimulation model plan based, at least in part, on the one or more plan equipment and the pumping rate.
